(19) United States
(12) Patent Application Publication
(10) Pub. No.: US 2026/0230347 A1
(43) Pub. Date: Aug. 6, 2026

(54) MODULATION-BASED DOCSIS SCHEDULER

(71) Applicant: Charter Communications Operating, LLC, St. Louis, MO (US)

(72) Inventor: Charles Ivan Cook, Castle Rock, CO (US)

(21) Appl. No.: 19/044,984

(22) Filed: Feb. 4, 2025

(51) Int. Cl. H04L 12/28; H04N 21/61

(52) U.S. Cl. CPC H04L 12/2801; H04N 21/6118

(57) ABSTRACT

At a scheduler component of a cable network, obtain first data designated for a first downstream component of the cable network; and determine whether the first downstream component is capable of receiving the first data via a first channel of at least first and second available channels for the first downstream component. The first channel for the first downstream component has a modulation scheme capable of higher spectral efficiency than that for the second channel for the first downstream component. At the component, responsive to determining that the first downstream component is capable of receiving the first data via the first channel for the first downstream component, populate a first table to assign the first channel for the first downstream component to the first downstream component at a first specified time. Operate the cable network in accordance with the populated first table.

### FIELD OF THE INVENTION

The present invention relates generally to the electrical, electronic, and computer arts, and, more particularly, to broadband communications networks, such as hybrid fiber-coaxial (HFC) networks, and the like.

### BACKGROUND OF THE INVENTION

Data Over Cable Service Interface Specification (DOCSIS®, registered mark of Cable Television Laboratories, Inc., Louisville, COLORADO, UNITED STATES) is an international telecommunications standard that permits the addition of high-bandwidth data transfer to an existing cable television (CATV) system. It is used by many cable television operators to provide cable Internet access over their existing hybrid fiber-coaxial (HFC) infrastructure.

The current DOCSIS® network has amplifiers and passives that were designed to operate in a certain frequency spectrum. The operator of a broadband communications network, such as a cable multi-service operator (MSO), may desire to upgrade an existing network to operate at higher frequencies. However, carrying out such an upgrade with current techniques typically requires replacing all of the amplifiers in the network, which is expensive and inconvenient. In this regard, note that loss is a function of both distance and frequency; the higher the frequency, the greater the loss per unit distance. Indeed, the higher in the spectrum, the lower the distance between DOCSIS amplifiers—the physics of propagation says that the distance between amplifiers gets shorter the higher the spectrum.

### SUMMARY OF THE INVENTION

Principles of the invention provide techniques for a modulation-based DOCSIS scheduler. In one aspect, an exemplary method includes the operations of, at a scheduler component of a cable network, obtaining first data designated for a first downstream component of the cable network; at the scheduler component, determining whether the first downstream component is capable of receiving the first data via a first channel of at least first and second available channels for the first downstream component, wherein the first channel for the first downstream component has a modulation scheme capable of higher spectral efficiency than that for the second channel for the first downstream component; at the scheduler component, responsive to determining that the first downstream component is capable of receiving the first data via the first channel for the first downstream component, populating a first table to assign the first channel for the first downstream component to the first downstream component at a first specified time; and operating the cable network in accordance with the populated first table.

In another aspect, a non-transitory computer readable medium includes computer executable instructions which when executed by a processor cause the processor to perform a method including the steps of: at a scheduler component of a cable network, obtaining first data designated for a first downstream component of the cable network; at the scheduler component, determining whether the first downstream component is capable of receiving the first data via a first channel of at least first and second available channels for the first downstream component, wherein the first channel for the first downstream component has a modulation scheme capable of higher spectral efficiency than that for the second channel for the first downstream component; at the scheduler component, responsive to determining that the first downstream component is capable of receiving the first data via the first channel for the first downstream component, populating a first table to assign the first channel for the first downstream component to the first downstream component at a first specified time; and facilitating operation of the cable network in accordance with the populated first table.

In a further aspect, an exemplary system includes electronic circuitry configured to implement a scheduler component of a cable network, the electronic circuitry being configured to: obtain first data designated for a first downstream component of the cable network; determine whether the first downstream component is capable of receiving the first data via a first channel of at least first and second available channels for the first downstream component, wherein the first channel for the first downstream component has a modulation scheme capable of higher spectral efficiency than that for the second channel for the first downstream component; responsive to determining that the first downstream component is capable of receiving the first data via the first channel for the first downstream component, populate a first table to assign the first channel for the first downstream component to the first downstream component at a first specified time; and facilitate operating the cable network in accordance with the populated first table.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of an article of manufacture including a non-transitory machine-readable medium that contains one or more programs which when executed implement one or more method steps set forth herein; that is to say, a computer program product including a tangible computer readable recordable storage medium (or multiple such media) with computer usable program code for performing the method steps indicated. Furthermore, one or more embodiments of the invention or elements thereof can be implemented in the form of an apparatus including a memory and at least one processor that is coupled to the memory and operative to perform, or facilitate performance of, exemplary method steps. Yet further, in another aspect, one or more embodiments of the invention or elements thereof can be implemented in the form of means for carrying out one or more of the method steps described herein; the means can include (i) specialized hardware module(s), (ii) software module(s) stored in a tangible computer-readable recordable storage medium (or multiple such media) and implemented on a hardware processor, or (iii) a combination of (i) and (ii); any of (i)-(iii) implement the specific techniques set forth herein.

Aspects of the present invention can provide substantial beneficial technical effects. For example, one or more embodiments of the invention achieve one or more of:
improve the technological process of upgrading a broadband communications network by providing techniques wherein amplifiers in the network can be replaced gradually instead of all at once, while maintaining network functionality;
optimize the overall efficiency of a DOCSIS network or similar type of network by identifying and taking advantage of devices in the network that can perform at higher levels.

These and other features and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:
FIG. 1 is a block diagram of an exemplary embodiment of a system, within which one or more aspects of the invention can be implemented;

FIG. 2 is a functional block diagram illustrating an exemplary hybrid fiber-coaxial (HFC) divisional network configuration, useful within the system of FIG. 1;

FIG. 3 is a functional block diagram illustrating one exemplary HFC cable network head-end configuration, useful within the system of FIG. 1;

FIG. 4 is a functional block diagram illustrating one exemplary local service node configuration useful within the system of FIG. 1;

FIG. 5 is a functional block diagram of a premises network, including an exemplary centralized customer premises equipment (CPE) unit, interfacing with a head end such as that of FIG. 3;

FIG. 6 is a functional block diagram of an exemplary centralized CPE unit, useful within the system of FIG. 1;

FIG. 7 is a block diagram of a computer system useful in connection with one or more aspects of the invention;

FIG. 8 is a table showing division of capacity space into channel and time, in accordance with an aspect of the invention;

FIG. 9 is a bar chart providing an example of available capacity on different channels at different times, in accordance with an aspect of the invention;

FIG. 10 is a flow chart of an initialization process, in accordance with an aspect of the invention;

FIG. 11 is a flow chart of a resource mapping process, in accordance with an aspect of the invention;

FIG. 12 is a block diagram of an exemplary system, in accordance with an aspect of the invention; and

FIG. 13 is an exemplary table of achievable SNR per channel for each modem of a plurality of modems connected to a CMTS, in accordance with an aspect of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION OF PREFERRED EMBODIMENTS

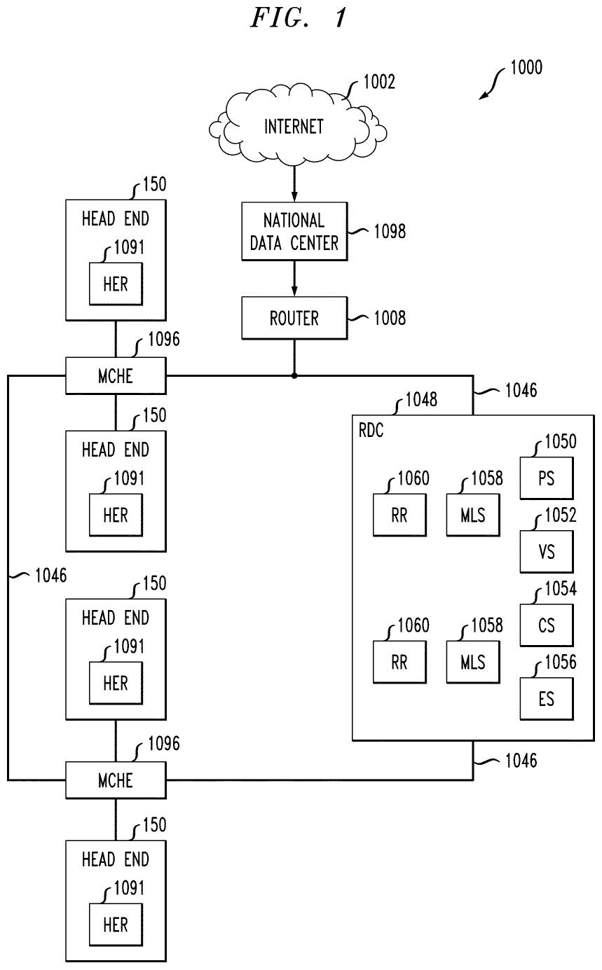

Purely by way of example and not limitation, some embodiments will be shown in the context of a cable multi-service operator (MSO) providing data services as well as entertainment services, it being understood that the example network of FIGS. 1-6 is but one example of many different networks that can employ a scheduler (by way of example and not limitation, a modulation-based DOCSIS scheduler) in accordance with aspects of the invention. FIG. 1 shows an exemplary system 1000, according to an aspect of the invention. System 1000 includes a regional data center (RDC) 1048 coupled to several Market Center Head Ends (MCHEs) 1096; each MCHE 1096 is in turn coupled to one or more divisions, represented by division head ends 150. In a non-limiting example, the MCHEs are coupled to the RDC 1048 via a network of switches and routers. One suitable example of network 1046 is a dense wavelength division multiplex (DWDM) network. The MCHEs can be employed, for example, for large metropolitan area(s). In addition, the MCHE is connected to localized HEs 150 via high-speed routers 1091 (“HER”=head end router) and a suitable network, which could, for example, also utilize DWDM technology. Elements 1048, 1096 on network 1046 may be operated, for example, by or on behalf of a cable MSO, and may be interconnected with a global system of interconnected computer networks that use the standardized Internet Protocol Suite (TCP/IP) (transfer control protocol/Internet protocol), commonly called the Internet 1002; for example, via router 1008. In one or more non-limiting exemplary embodiments, router 1008 is a point-of-presence (“POP”) router; for example, of the kind available from Juniper Networks, Inc., Sunnyvale, California, USA.

Head end routers 1091 are omitted from figures below to avoid clutter, and not all switches, routers, etc. associated with network 1046 are shown, also to avoid clutter.

RDC 1048 may include one or more provisioning servers (PS) 1050, one or more Video Servers (VS) 1052, one or more content servers (CS) 1054, and one or more e-mail servers(ES) 1056. The same may be interconnected to one or more RDC routers (RR) 1060 by one or more multi-layer switches (MLS) 1058. RDC routers 1060 interconnect with network 1046.

A national data center (NDC) 1098 is provided in some instances; for example, between router 1008 and Internet 1002. In one or more embodiments, such an NDC may consolidate at least some functionality from head ends (local and/or market center) and/or regional data centers. For example, such an NDC might include one or more VOD servers; switched digital video (SDV) functionality; gateways to obtain content (e.g., program content) from various sources including cable feeds and/or satellite; and so on.

In some cases, there may be more than one national data center 1098 (e.g., two) to provide redundancy. There can be multiple regional data centers 1048. In some cases, MCHEs could be omitted and the local head ends 150 coupled directly to the RDC 1048.

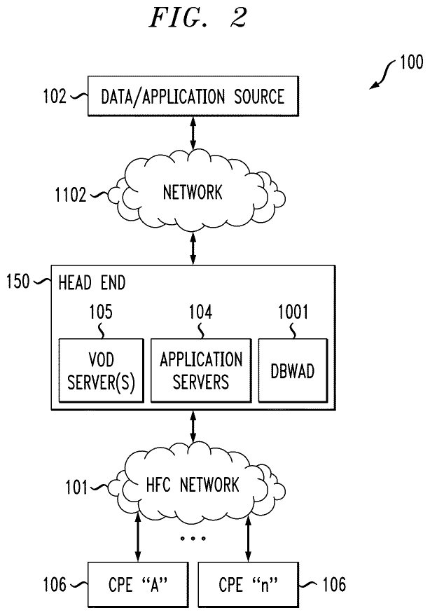

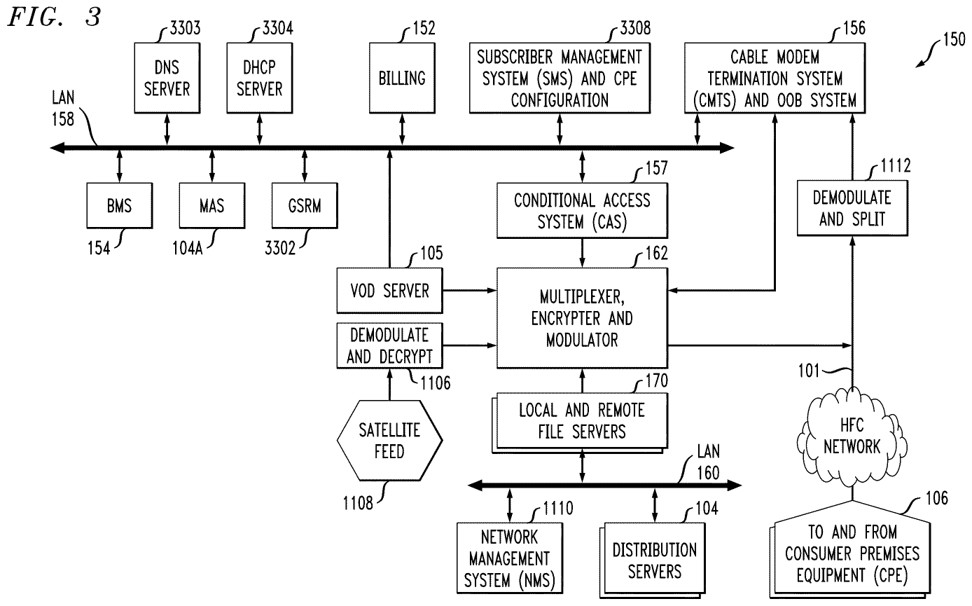

FIG. 2 is a functional block diagram illustrating an exemplary content-based (e.g., hybrid fiber-coaxial (HFC)) divisional network configuration, useful within the system of FIG. 1. See, for example, US Patent Publication 2006/0130107 of Gonder et al., entitled “Method and apparatus for high bandwidth data transmission in content-based networks,” the complete disclosure of which is expressly incorporated by reference herein in its entirety for all purposes. The various components of the network 100 include (i) one or more data and application origination points 102; (ii) one or more application distribution servers 104; (iii) one or more video-on-demand (VOD) servers 105, and (v) consumer premises equipment or customer premises equipment (CPE). The distribution server(s) 104, VOD servers 105 and CPE(s) 106 are connected via a bearer (e.g., HFC) network 101. Servers 104, 105 can be located in head end 150. A simple architecture is shown in FIG. 2 for illustrative brevity, although it will be recognized that comparable architectures with multiple origination points, distribution servers, VOD servers, and/or CPE devices (as well as different network topologies) may be utilized consistent with embodiments of the invention. For example, the head-end architecture of FIG. 3 (described in greater detail below) may be used.

It should be noted that the exemplary CPE 106 is an integrated solution including a cable modem (e.g., DOCSIS) and one or more wireless routers. Other embodiments could employ a two-box solution; i.e., separate cable modem and routers suitably interconnected, which nevertheless, when interconnected, can provide equivalent functionality. Furthermore, FTTH networks can employ Service ONUs (S-ONUs; ONU=optical network unit) as CPE, as discussed elsewhere herein. Still further, cable modems 4028 discussed below can be stand-alone or integrated.

The data/application origination point 102 comprises any medium that allows data and/or applications (such as a VOD-based or “Watch TV” application) to be transferred to a distribution server 104, for example, over network 1102. This can include for example a third-party data source, application vendor website, compact disk read-only memory (CD-ROM), external network interface, mass storage device (e.g., Redundant Arrays of Inexpensive Disks (RAID) system), etc. Such transference may be automatic, initiated upon the occurrence of one or more specified events (such as the receipt of a request packet or acknowledgement (ACK)), performed manually, or accomplished in any number of other modes readily recognized by those of ordinary skill, given the teachings herein. For example, in one or more embodiments, network 1102 may correspond to network 1046 of FIG. 1, and the data and application origination point may be, for example, within NDC 1098, RDC 1048, or on the Internet 1002. Head end 150, HFC network 101, and CPEs 106 thus represent the divisions which were represented by division head ends 150 in FIG. 1.

The application distribution server 104 comprises a computer system where such applications can enter the network system. Distribution servers per se are well known in the networking arts, and accordingly not described further herein.

The VOD server 105 comprises a computer system where on-demand content can be received from one or more of the aforementioned data sources 102 and enter the network system. These servers may generate the content locally, or alternatively act as a gateway or intermediary from a distant source.

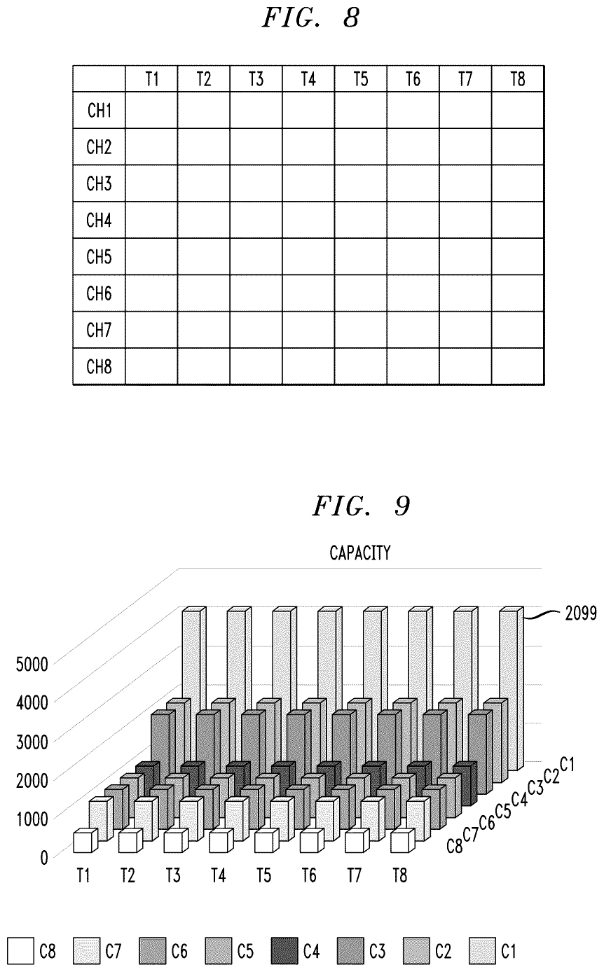

The CPE 106 includes any equipment in the “customers'premises” (or other appropriate locations) that can be accessed by the relevant upstream network components. Non-limiting examples of relevant upstream network components, in the context of the HFC network, include a distribution server 104 or a cable modem termination system 156 (discussed below with regard to FIG. 3). The skilled artisan will be familiar with other relevant upstream network components for other kinds of networks (e.g., FTTH) as discussed herein. Non-limiting examples of CPE are set-top boxes, high-speed cable modems, and Advanced Wireless Gateways (AWGs) for providing high bandwidth Internet access in premises such as homes and businesses. Reference is also made to the discussion of an exemplary FTTH network in connection with FIGS. 8 and 9.

Also included (for example, in head end 150) is a dynamic bandwidth allocation device (DBWAD) 1001 such as a global session resource manager, which is itself a non-limiting example of a session resource manager.

FIG. 3 is a functional block diagram illustrating one exemplary HFC cable network head-end configuration, useful within the system of FIG. 1. As shown in FIG. 3, the head-end architecture 150 comprises typical head-end components and services including billing module 152, subscriber management system (SMS) and CPE configuration management module 3308, cable-modem termination system (CMTS) and out-of-band (OOB) system 156, as well as LAN(s) 158, 160 placing the various components in data communication with one another. In one or more embodiments, there are multiple CMTSs. Each may be coupled to an HER 1091, for example. See, e.g., FIGS. 1 and 2 of co-assigned U.S. Pat. No. 7,792,963 of inventors Gould and Danforth, entitled METHOD TO BLOCK UNAUTHORIZED NETWORK TRAFFIC IN A CABLE DATA NETWORK, the complete disclosure of which is expressly incorporated herein by reference in its entirety for all purposes.

It will be appreciated that while a bar or bus LAN topology is illustrated, any number of other arrangements (e.g., ring, star, etc.) may be used consistent with the invention. It will also be appreciated that the head-end configuration depicted in FIG. 3 is high-level, conceptual architecture and that each multi-service operator (MSO) may have multiple head-ends deployed using custom architectures.

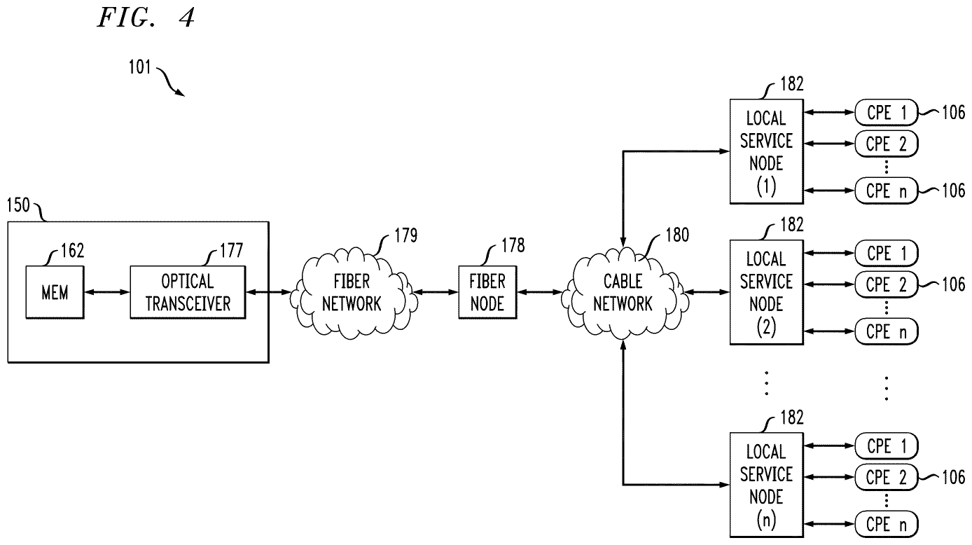

The architecture 150 of FIG. 3 further includes a multiplexer/encrypter/modulator (MEM) 162 coupled to the HFC network 101 adapted to “condition” content for transmission over the network. The distribution servers 104 are coupled to the LAN 160, which provides access to the MEM 162 and network 101 via one or more file servers 170. The VOD servers 105 are coupled to the LAN 158, although other architectures may be employed (such as for example where the VOD servers are associated with a core switching device such as an 802.3z Gigabit Ethernet device; or the VOD servers could be coupled to LAN 160). Since information is typically carried across multiple channels, the head-end should be adapted to acquire the information for the carried channels from various sources. Typically, the channels being delivered from the head-end 150 to the CPE 106 (“downstream”) are multiplexed together in the head-end and sent to neighborhood hubs (refer to description of FIG. 4) via a variety of interposed network components.

Content (e.g., audio, video, etc.) is provided in each downstream (in-band) channel associated with the relevant service group. (Note that in the context of data communications, internet data is passed both downstream and upstream.) To communicate with the head-end or intermediary node (e.g., hub server), the CPE 106 may use the out-of-band (OOB) or DOCSIS® (Data Over Cable Service Interface Specification) channels (registered mark of Cable Television Laboratories, Inc., 400 Centennial Parkway Louisville CO 80027, USA) and associated protocols (e.g., DOCSIS 1.x, 2.0. or 3.0). The OpenCable™ Application Platform (OCAP) 1.0, 2.0, 3.0 (and subsequent) specification (Cable Television laboratories Inc.) provides for exemplary networking protocols both downstream and upstream, although the invention is in no way limited to these approaches. All versions of the DOCSIS and OCAP specifications are expressly incorporated herein by reference in their entireties for all purposes.

Furthermore in this regard, DOCSIS is an international telecommunications standard that permits the addition of high-speed data transfer to an existing cable TV (CATV) system. It is employed by many cable television operators to provide Internet access (cable Internet) over their existing hybrid fiber-coaxial (HFC) infrastructure. HFC systems using DOCSIS to transmit data are one non-limiting exemplary application context for one or more embodiments. However, one or more embodiments are applicable to a variety of different kinds of networks.

It is also worth noting that the use of DOCSIS Provisioning of EPON (Ethernet over Passive Optical Network) or “DPoE” (Specifications available from CableLabs, Louisville, CO, USA) enables the transmission of high-speed data over PONs using DOCSIS back-office systems and processes.

It will also be recognized that multiple servers (broadcast, VOD, or otherwise) can be used, and disposed at two or more different locations if desired, such as being part of different server “farms”. These multiple servers can be used to feed one service group, or alternatively different service groups. In a simple architecture, a single server is used to feed one or more service groups. In another variant, multiple servers located at the same location are used to feed one or more service groups. In yet another variant, multiple servers disposed at different location are used to feed one or more service groups.

In some instances, material may also be obtained from a satellite feed 1108; such material is demodulated and decrypted in block 1106 and fed to block 162. Conditional access system 157 may be provided for access control purposes. Network management system 1110 may provide appropriate management functions. Note also that signals from MEM 162 and upstream signals from network 101 that have been demodulated and split in block 1112 are fed to CMTS and OOB system 156.

Also included in FIG. 3 are a global session resource manager (GSRM) 3302, a Mystro Application Server 104A, and a business management system 154, all of which are coupled to LAN 158. GSRM 3302 is one specific form of a DBWAD 1001 and is a non-limiting example of a session resource manager.

An ISP DNS server could be located in the head-end as shown at 3303, but it can also be located in a variety of other places. One or more Dynamic Host Configuration Protocol (DHCP) server(s) 3304 can also be located where shown or in different locations.

It should be noted that the exemplary architecture in FIG. 3 shows a traditional location for the CMTS 156 in a head end. As will be appreciated by the skilled artisan, CMTS functionality can be moved down closer to the customers or up to a national or regional data center or can be dispersed into one or more locations.

As shown in FIG. 4, the network 101 of FIGS. 2 and 3 comprises a fiber/coax arrangement wherein the output of the MEM 162 of FIG. 3 is transferred to the optical domain (such as via an optical transceiver 177 at the head-end 150 or further downstream). The optical domain signals are then distributed over a fiber network 179 to a fiber node 178, which further distributes the signals over a distribution network 180 (typically coax) to a plurality of local servicing nodes 182. This provides an effective 1-to-N expansion of the network at the local service end. Each node 182 services a number of CPEs 106. Further reference may be had to US Patent Publication 2007/0217436 of Markley et al., entitled “Methods and apparatus for centralized content and data delivery,” the complete disclosure of which is expressly incorporated herein by reference in its entirety for all purposes. In one or more embodiments, the CPE 106 includes a cable modem, such as a DOCSIS-compliant cable modem (DCCM). Please note that the number n of CPE 106 per node 182 may be different than the number n of nodes 182, and that different nodes may service different numbers n of CPE.

Certain additional aspects of video or other content delivery will now be discussed. It should be understood that embodiments of the invention have broad applicability to a variety of different types of networks. Some embodiments relate to TCP/IP network connectivity for delivery of messages and/or content. Again, delivery of data over a video (or other) content network is but one non-limiting example of a context where one or more embodiments could be implemented. US Patent Publication 2003-0056217 of Paul D. Brooks, entitled “Technique for Effectively Providing Program Material in a Cable Television System,” the complete disclosure of which is expressly incorporated herein by reference for all purposes, describes one exemplary broadcast switched digital architecture, although it will be recognized by those of ordinary skill that other approaches and architectures may be substituted. In a cable television system in accordance with the Brooks invention, program materials are made available to subscribers in a neighborhood on an as-needed basis. Specifically, when a subscriber at a set-top terminal selects a program channel to watch, the selection request is transmitted to a head end of the system. In response to such a request, a controller in the head end determines whether the material of the selected program channel has been made available to the neighborhood. If it has been made available, the controller identifies to the set-top terminal the carrier which is carrying the requested program material, and to which the set-top terminal tunes to obtain the requested program material. Otherwise, the controller assigns an unused carrier to carry the requested program material, and informs the set-top terminal of the identity of the newly assigned carrier. The controller also retires those carriers assigned for the program channels which are no longer watched by the subscribers in the neighborhood. Note that reference is made herein, for brevity, to features of the “Brooks invention”—it should be understood that no inference should be drawn that such features are necessarily present in all claimed embodiments of Brooks. The Brooks invention is directed to a technique for utilizing limited network bandwidth to distribute program materials to subscribers in a community access television (CATV) system. In accordance with the Brooks invention, the CATV system makes available to subscribers selected program channels, as opposed to all of the program channels furnished by the system as in prior art. In the Brooks CATV system, the program channels are provided on an as needed basis, and are selected to serve the subscribers in the same neighborhood requesting those channels.

US Patent Publication 2010-0313236 of Albert Straub, entitled “TECHNIQUES FOR UPGRADING SOFTWARE IN A VIDEO CONTENT NETWORK,” the complete disclosure of which is expressly incorporated herein by reference for all purposes, provides additional details on the aforementioned dynamic bandwidth allocation device 1001.

US Patent Publication 2009-0248794 of William L. Helms, entitled “SYSTEM AND METHOD FOR CONTENT SHARING,” the complete disclosure of which is expressly incorporated herein by reference for all purposes, provides additional details on CPE in the form of a converged premises gateway device. Related aspects are also disclosed in US Patent Publication 2007-0217436 of Markley et al, entitled “METHODS AND APPARATUS FOR CENTRALIZED CONTENT AND DATA DELIVERY,” the complete disclosure of which is expressly incorporated herein by reference for all purposes.

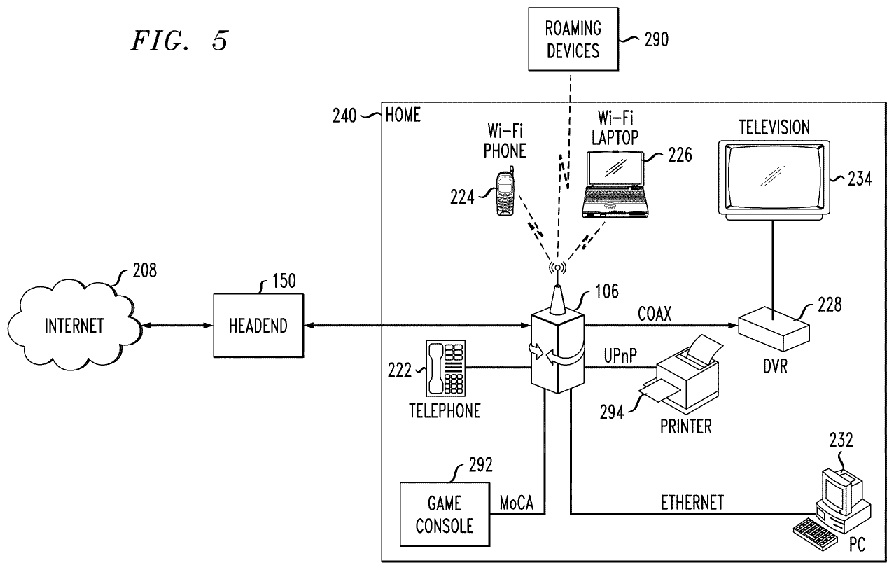

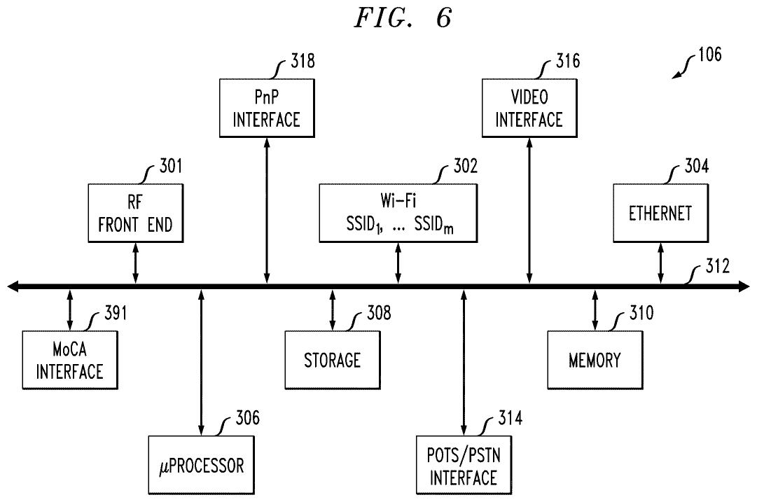

Reference should now be had to FIG. 5, which presents a block diagram of a premises network interfacing with a head end of an MSO or the like, providing Internet access. An exemplary advanced wireless gateway comprising CPE 106 is depicted as well. It is to be emphasized that the specific form of CPE 106 shown in FIGS. 5 and 6 is exemplary and non-limiting, and shows a number of optional features. Many other types of CPE can be employed in one or more embodiments; for example, a cable modem, DSL modem, and the like. The CPE can also be a Service Optical Network Unit (S-ONU) for FTTH deployment-see FIGS. 8 and 9 and accompanying text.

CPE 106 includes an advanced wireless gateway which connects to a head end 150 or other hub of a network, such as a video content network of an MSO or the like. The head end is coupled also to an internet (e.g., the Internet) 208 which is located external to the head end 150, such as via an Internet (IP) backbone or gateway (not shown).

The head end is in the illustrated embodiment coupled to multiple households or other premises, including the exemplary illustrated household 240. In particular, the head end (for example, a cable modem termination system 156 thereof) is coupled via the aforementioned HFC network and local coaxial cable or fiber drop to the premises, including the consumer premises equipment (CPE) 106. The exemplary CPE 106 is in signal communication with any number of different devices including, e.g., a wired telephony unit 222, a Wi-Fi or other wireless-enabled phone 224, a Wi-Fi or other wireless-enabled laptop 226, a session initiation protocol (SIP) phone, an H.323 terminal or gateway, etc. Additionally, the CPE 106 is also coupled to a digital video recorder (DVR) 228 (e.g., over coax), in turn coupled to television 234 via a wired or wireless interface (e.g., cabling, PAN or 802.15 UWB micro-net, etc.). CPE 106 is also in communication with a network (here, an Ethernet network compliant with IEEE Std. 802.3, although any number of other network protocols and topologies could be used) on which is a personal computer (PC) 232.

Other non-limiting exemplary devices that CPE 106 may communicate with include a printer 294; for example, over a universal plug and play (UPnP) interface, and/or a game console 292; for example, over a multimedia over coax alliance (MoCA) interface.

In some instances, CPE 106 is also in signal communication with one or more roaming devices, generally represented by block 290.

A “home LAN” (HLAN) is created in the exemplary embodiment, which may include for example the network formed over the installed coaxial cabling in the premises, the Wi-Fi network, and so forth.

During operation, the CPE 106 exchanges signals with the head end over the interposed coax (and/or other, e.g., fiber) bearer medium. The signals include e.g., Internet traffic (IPv4 or IPv6), digital programming and other digital signaling or content such as digital (packet-based; e.g., VoIP) telephone service. The CPE 106 then exchanges this digital information after demodulation and any decryption (and any demultiplexing) to the particular system(s) to which it is directed or addressed. For example, in one embodiment, a MAC address or IP address can be used as the basis of directing traffic within the client-side environment 240.

Any number of different data flows may occur within the network depicted in FIG. 5. For example, the CPE 106 may exchange digital telephone signals from the head end which are further exchanged with the telephone unit 222, the Wi-Fi phone 224, or one or more roaming devices 290. The digital telephone signals may be IP-based such as Voice-over-IP (VoIP), or may utilize another protocol or transport mechanism. The well-known session initiation protocol (SIP) may be used, for example, in the context of a “SIP phone” for making multi-media calls. The network may also interface with a cellular or other wireless system, such as for example a 3G IMS (IP multimedia subsystem) system, in order to provide multimedia calls between a user or consumer in the household domain 240 (e.g., using a SIP phone or H.323 terminal) and a mobile 3G telephone or personal media device (PMD) user via that user's radio access network (RAN).

The CPE 106 may also exchange Internet traffic (e.g., TCP/IP and other packets) with the head end 150 which is further exchanged with the Wi-Fi laptop 226, the PC 232, one or more roaming devices 290, or other device. CPE 106 may also receive digital programming that is forwarded to the DVR 228 or to the television 234. Programming requests and other control information may be received by the CPE 106 and forwarded to the head end as well for appropriate handling.

FIG. 6 is a block diagram of one exemplary embodiment of the CPE 106 of FIG. 5. The exemplary CPE 106 includes an RF front end 301, Wi-Fi interface 302, video interface 316, “Plug n′ Play” (PnP) interface 318 (for example, a UPnP interface) and Ethernet interface 304, each directly or indirectly coupled to a bus 312. In some cases, Wi-Fi interface 302 comprises a single wireless access point (WAP) running multiple (“m”) service set identifiers (SSIDs). In some cases, multiple SSIDs, which could represent different applications, are served from a common WAP. For example, SSID 1 is for the home user, while SSID 2 may be for a managed security service, SSID 3 may be a managed home networking service, SSID 4 may be a hot spot, and so on. Each of these is on a separate IP subnetwork for security, accounting, and policy reasons. The microprocessor 306, storage unit 308, plain old telephone service (POTS)/public switched telephone network (PSTN) interface 314, and memory unit 310 are also coupled to the exemplary bus 312, as is a suitable MoCA interface 391. The memory unit 310 typically comprises a random-access memory (RAM) and storage unit 308 typically comprises a hard disk drive, an optical drive (e.g., CD-ROM or DVD), NAND flash memory, RAID (redundant array of inexpensive disks) configuration, or some combination thereof.

The illustrated CPE 106 can assume literally any discrete form factor, including those adapted for desktop, floor-standing, or wall-mounted use, or alternatively may be integrated in whole or part (e.g., on a common functional basis) with other devices if desired.

Again, it is to be emphasized that every embodiment need not necessarily have all the elements shown in FIG. 6—as noted, the specific form of CPE 106 shown in FIGS. 5 and 6 is exemplary and non-limiting, and shows a number of optional features. Yet again, many other types of CPE can be employed in one or more embodiments; for example, a cable modem, DSL modem, and the like.

It will be recognized that while a linear or centralized bus architecture is shown as the basis of the exemplary embodiment of FIG. 6, other bus architectures and topologies may be used. For example, a distributed or multi-stage bus architecture may be employed. Similarly, a “fabric” or other mechanism (e.g., crossbar switch, RAPIDIO interface, non-blocking matrix, TDMA or multiplexed system, etc.) may be used as the basis of at least some of the internal bus communications within the device. Furthermore, many if not all of the foregoing functions may be integrated into one or more integrated circuit (IC) devices in the form of an ASIC or “system-on-a-chip” (SoC). Myriad other architectures well known to those in the data processing and computer arts may accordingly be employed.

Yet again, it will also be recognized that the CPE configuration shown is essentially for illustrative purposes, and various other configurations of the CPE 106 are consistent with other embodiments of the invention. For example, the CPE 106 in FIG. 6 may not include all of the elements shown, and/or may include additional elements and interfaces such as for example an interface for the HomePlug A/V standard which transmits digital data over power lines, a PAN (e.g., 802.15), Bluetooth, or other short-range wireless interface for localized data communication, etc.

A suitable number of standard 10/100/1000 Base T Ethernet ports for the purpose of a Home LAN connection are provided in the exemplary device of FIG. 6; however, it will be appreciated that other rates (e.g., Gigabit Ethernet or 10-Gig-E) and local networking protocols (e.g., MoCA, USB, etc.) may be used. These interfaces may be serviced via a WLAN interface, wired RJ-45 ports, or otherwise. The CPE 106 can also include a plurality of RJ-11 ports for telephony interface, as well as a plurality of USB (e.g., USB 2.0, USB 3.x, USB 4) ports, and IEEE-1394 (Firewire) ports. S-video and other signal interfaces may also be provided if desired.

During operation of the CPE 106, software located in the storage unit 308 is run on the microprocessor 306 using the memory unit 310 (e.g., a program memory within or external to the microprocessor). The software controls the operation of the other components of the system, and provides various other functions within the CPE. Other system software/firmware may also be externally reprogrammed, such as using a download and reprogramming of the contents of the flash memory, replacement of files on the storage device or within other non-volatile storage, etc. This allows for remote reprogramming or reconfiguration of the CPE 106 by the MSO or other network agent.

It should be noted that some embodiments provide a cloud-based user interface, wherein CPE 106 accesses a user interface on a server in the cloud, such as in NDC 1098.

The RF front end 301 of the exemplary embodiment comprises a cable modem of the type known in the art. In some cases, the CPE just includes the cable modem and omits the optional features. Content or data normally streamed over the cable modem can be received and distributed by the CPE 106, such as, for example, packetized video (e.g., IPTV). The digital data exchanged using RF front end 301 includes IP or other packetized protocol traffic that provides access to internet service. As is well known in cable modem technology, such data may be streamed over one or more dedicated QAMs resident on the HFC bearer medium, or even multiplexed or otherwise combined with QAMs allocated for content delivery, etc. The packetized (e.g., IP) traffic received by the CPE 106 may then be exchanged with other digital systems in the local environment 240 (or outside this environment by way of a gateway or portal) via, e.g., the Wi-Fi interface 302, Ethernet interface 304 or plug-and-play (PnP) interface 318.

Additionally, the RF front end 301 modulates, encrypts/multiplexes as required, and transmits digital information for receipt by upstream entities such as the CMTS or a network server. Digital data transmitted via the RF front end 301 may include, for example, MPEG-2 encoded programming data that is forwarded to a television monitor via the video interface 316. Programming data may also be stored on the CPE storage unit 308 for later distribution by way of the video interface 316, or using the Wi-Fi interface 302, Ethernet interface 304, Firewire (IEEE Std. 1394), USB/USB2/USB 3.x, USB4, or any number of other such options.

Other devices such as portable music players (e.g., MP3 audio players) may be coupled to the CPE 106 via any number of different interfaces, and music and other media files downloaded for portable use and viewing.

In some instances, the CPE 106 includes a DOCSIS cable modem for delivery of traditional broadband Internet services. This connection can be shared by all Internet devices in the premises 240; e.g., Internet protocol television (IPTV) devices, PCs, laptops, etc., as well as by roaming devices 290. In addition, the CPE 106 can be remotely managed (such as from the head end 150, or another remote network agent) to support appropriate IP services. Some embodiments could utilize a cloud-based user interface, wherein CPE 106 accesses a user interface on a server in the cloud, such as in NDC 1098.

In some instances, the CPE 106 also creates a home Local Area Network (LAN) utilizing the existing coaxial cable in the home. For example, an Ethernet-over-coax based technology allows services to be delivered to other devices in the home utilizing a frequency outside (e.g., above) the traditional cable service delivery frequencies. For example, frequencies on the order of 1150 MHz could be used to deliver data and applications to other devices in the home such as PCs, PMDs, media extenders and set-top boxes. The coaxial network is merely the bearer; devices on the network utilize Ethernet or other comparable networking protocols over this bearer.

The exemplary CPE 106 shown in FIGS. 5 and 6 acts as a Wi-Fi access point (AP), thereby allowing Wi-Fi enabled devices to connect to the home network and access Internet, media, and other resources on the network. This functionality can be omitted in one or more embodiments.

In one embodiment, Wi-Fi interface 302 comprises a single wireless access point (WAP) running multiple (“m”) service set identifiers (SSIDs). One or more SSIDs can be set aside for the home network while one or more SSIDs can be set aside for roaming devices 290.

A premises gateway software management package (application) is also provided to control, configure, monitor and provision the CPE 106 from the cable head-end 150 or other remote network node via the cable modem (DOCSIS) interface. This control allows a remote user to configure and monitor the CPE 106 and home network. Yet again, it should be noted that some embodiments could employ a cloud-based user interface, wherein CPE 106 accesses a user interface on a server in the cloud, such as in NDC 1098. The MoCA interface 391 can be configured, for example, in accordance with the MoCA 1.0, 1.1, or 2.0 specifications.

As discussed above, the optional Wi-Fi wireless interface 302 is, in some instances, also configured to provide a plurality of unique service set identifiers (SSIDs) simultaneously. These SSIDs are configurable (locally or remotely), such as via a web page.

In addition to “broadcast” content (e.g., video programming), the system of FIGS. 1-6 delivers Internet data services using the Internet protocol (IP), although other protocols and transport mechanisms of the type well known in the digital communication art may be substituted. In the systems of FIGS. 1-6, the IP packets are typically transmitted on RF channels that are different that the RF channels used for the broadcast video and audio programming, although this is not a requirement. The CPE 106 are each configured to monitor the particular assigned RF channel (such as via a port or socket ID/address, or other such mechanism) for IP packets intended for the subscriber premises/address that they serve. Furthermore, one or more embodiments could be adapted to situations where a cable/fiber broadband operator provides wired broad band data connectivity but does not provide QAM-based broadcast video.

Principles of the present disclosure will be described herein in the context of techniques for a modulation-based DOCSIS scheduler. It is to be appreciated, however, that the specific apparatus and/or methods illustratively shown and described herein are to be considered exemplary as opposed to limiting. Moreover, it will become apparent to those skilled in the art given the teachings herein that numerous modifications can be made to the embodiments shown that are within the scope of the appended claims. That is, no limitations with respect to the embodiments shown and described herein are intended or should be inferred.

A scheduler is a mechanism that assigns network resources, such as bandwidth capacity, to a user. A typical system has a bandwidth capacity; the capacity is a limited resource. Multiple users subscribe to the system and request resources as necessary. For example, a DOCSIS system may have a bandwidth capacity of 10 Gbps. The system may have 100 users that have registered to use the bandwidth of the system. The system delivers the bandwidth over a shared HFC plant. Since the HFC plant is shared, the scheduler orchestrates the system to deliver the bandwidth to the requesting user. The system typically does this by enabling one or more bandwidth channels of a specified capacity for a specified duration of time, and informing the user of the assigned bandwidth channels and when they are assigned for use by the user.

In a traditional DOCSIS network, a bandwidth channel has a specified capacity based on the spectral bandwidth of the channel and the modulation of the channel. Different modulation schemes deliver different spectral efficiency (bits/s/Hz) levels of performance. Different modulation schemes also typically require different levels of signal-to-noise ratio (SNR) in order to successfully modulate the data without loss of data. If the minimum SNR requirements for a particular modulation scheme are not met, data errors will result. Consequently, in one or more embodiments, the system resolves down to a lower (less complex) modulation scheme that can function with a lower SNR. This tradeoff results in a lower bits/s/Hz, but data integrity is maintained. Note that “modulation(s)” may be used herein as a shorthand for “modulation scheme(s)” in some instances—this will be apparent to the skilled artisan from the context.

It is worth noting that current DOCSIS systems use quadrature amplitude modulation (QAM), but other modulation schemes could be used in similar and/or future systems. For example, there are modified QAM constellations that are not square. There are also probabilistic QAM modulation schemes, phase-shift keying (PSK) modulation schemes, etc. If the SNR is particularly problematic, the modulation scheme used could be binary phase shift keying (BPSK).

If the current DOCSIS system supports PMA (Profile Management Application), the DOCSIS system determines the maximum bits/s/Hz that can be supported on the coaxial distribution plant for each channel, and sets the modulation scheme for each channel to deliver the maximum bits/s/Hz. Otherwise, the same lowest common denominator for modulation scheme is used for all the channels. For example, if the worst channel can only support 256 QAM modulation, then all channels are provisioned to 256 QAM.

It is worth noting that PMA is typically applied to all devices on the same service group for hours at a time, regardless of where they are geospatially on the network, whereas one or more embodiments consider where each device is based on SNR/Carrier to Noise Ratio (CNR) to further improve performance. Examples presented herein in the context of SNR can also be adapted to utilize CNR, as would be apparent to the skilled artisan, given the teachings herein.

Since the coaxial distribution plant is shared, and since a user can be located anywhere on the coaxial plant, the modulation scheme is determined by the modem that, in general, is “farthest away” from an SNR perspective (not necessarily from a geospatial perspective). Hence, the longer the coaxial plant from the CMTS/remote physical device (RPD) to the farthest modem, the lower the modulation scheme must be, and the overall capacity is lower. The skilled artisan will be familiar with the Converged Cable Access Platform (CCAP), the concept of a remote physical device (RPD), the concept of a Remote MACPHY Device (RMD), and with the relevant standards, such as the existing “Remote-Phy” standards, including Data-Over-Cable Service Interface Specifications DCA-MHAv2, Modular Headend Architecture v2 Technical Report, CM-TR-MHAv2-V01-150615, Cable Television Laboratories, Inc. 2014-2015, Jun. 15, 2015, and Data-Over-Cable Service Interface Specifications DCA, Distributed CCAP Architectures Overview Technical Report, CM-TR-DCA-V01-150908, Cable Television Laboratories, Inc. 2015, Sep. 8, 2015, both of which are hereby expressly incorporated herein by reference in their entireties for all purposes.

Current schedulers typically assign bandwidth through allocating one or more channels for a duration of time. Additionally, current schedulers typically also have “fairness” and “priority” parameters that come into play when the system approaches capacity and becomes congested.

One or more embodiments advantageously enable additional capacity by enabling a scheduler in accordance with aspects of the invention to consider the achievable SNR to each user and dynamically adjusting the modulation scheme to maximize the capacity of the coaxial plant. This capability becomes increasingly important as the network evolves to use higher and higher spectrum.

The actives (e.g., amplifiers, range extenders) and passives (e.g., taps) in a coaxial plant are limited in how much spectrum they can operate over. Current actives and passives are capable of supporting a 1 to 1.2 GHz plant. Older actives and passives may only support an 850 MHz plant or less. To evolve to a higher spectral plant such as 1.8 GHz or higher, using current technology, all of the actives and passives must be replaced at the same time, and potentially respaced so that they are closer together due to the link budget performance capabilities of the equipment.

Advantageously, one or more embodiments allow for the network to be gradually upgraded by replacing the amplifiers and taps that are closest to the CMTS/RPDs first, then the second closest, then the third closest, etc. By replacing the closest actives and passives, the closest part of the coaxial plant can now support more spectrum even though the rest of the plant cannot.

In one or more embodiments, the scheduler only assigns channels in the higher spectrum to the “closer” (in the SNR sense) modems on that portion of the coaxial plant that can support it—the rest of the coaxial plant that has not been upgraded continues to perform as it did before.

### Exemplary Algorithm

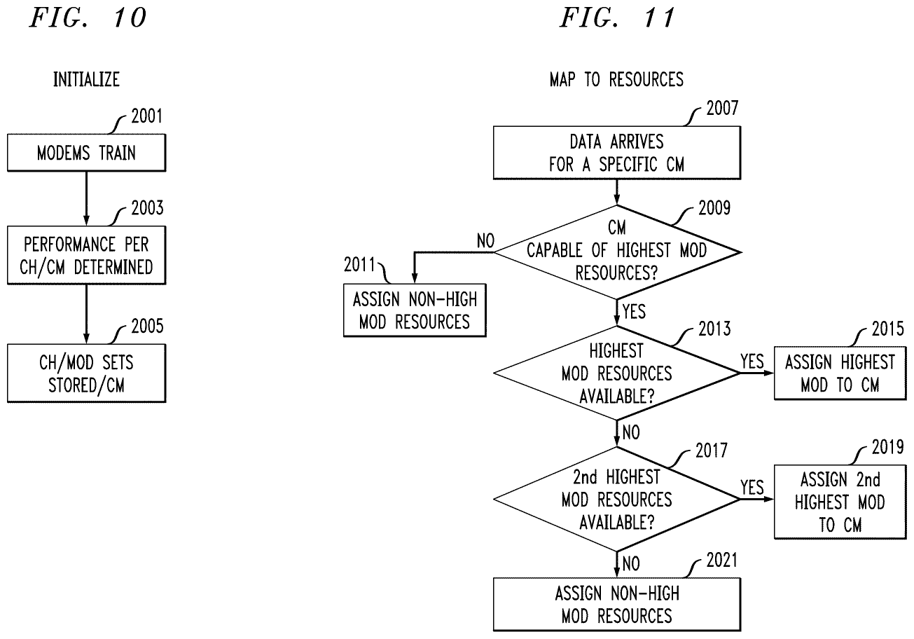

Referring to FIG. 10, in one or more non-limiting exemplary embodiments, as per step 2001, each modem trains up on the network. The training process determines the optimal channel/modulation schemes for that specific modem, as indicated in step 2003, and is discussed further below. In step 2005, channel/modulation scheme information for the specific modem is stored in the network (e.g., a cloud-based database). This process is repeated for each modem on the network as it trains up. Referring to FIG. 11, in one or more embodiments, the scheduler uses the database to select which channels and modulation schemes to use. Referring to step 2007, when data comes in to be delivered to a particular modem, the scheduler looks up the set of channels/modulation schemes available for that modem. If the modem is located in the network such that it can support higher spectrum channels (YES branch of decision block 2009), the scheduler allocates the higher spectrum channels to that modem, which makes more bandwidth available on the rest of the network. If not (NO branch of decision block 2009), then the scheduler does not allocate the higher spectrum channels to that modem, as per step 2011.

It is worth noting that, in the exemplary process depicted in FIG. 10, the performance can be based on the SNR and/or CNR. It is then appropriate, for example, to map the SNR/CNR to the modulation scheme that provides the best bits/s/Hz that can be supported by the SNR/CNR (Carrier to Noise Ratio). Further generalization is thus possible; the process is not limited to QAM modulations. Indeed, while currently, DOCSIS uses QAM modulations, other systems and/or a future DOCSIS system may use other types of modulation. It is also worth noting that in one or more embodiments, the process in FIG. 10 can occur with the modem first comes on line. The process can subsequently be repeated periodically or on demand to ensure that the mappings are up to date. Network reconfigurations, temperature, damage to the cable, etc. can make it appropriate to update the data in the table.

In the case where the modem is located such that it can support higher spectrum channels (YES branch of decision block 2009), further optional steps can be performed. In decision block 2013, determine whether the highest modulation scheme resources are available. If so (YES branch of block 2013), assign the highest modulation scheme resources to that cable modem in step 2015. If not (NO branch of block 2013), proceed to decision block 2017. In decision block 2017, determine whether the second highest modulation scheme resources are available. If so (YES branch of block 2017), assign the second highest modulation scheme resources to that cable modem in step 2019. If not (NO branch of block 2017), proceed to block 2021 and do not allocate the higher spectrum channels to that modem. Note that additional tiers of “high” modulation resources and corresponding additional decision and assignment blocks are possible.

In one or more embodiments, from a CMTS/virtualized cable modem termination system (vCMTS) perspective, the capacity space is divided up into channel (e.g., CH1-CH8), and time (e.g., T1-T8), as seen in FIG. 8. Each CH/T (channel/time) combination has a capacity based on the modulation scheme of the channel. Modems are assigned to one or more channels for a predetermined period of time. Note that FIG. 8 is an exemplary illustration of the available CH/T resources. Suppose that CH1 is the channel that is highest in the spectrum, and modem 1 has been identified that it can successfully operate on CH1 based on SNR measurements. The scheduler can assign CH1/T1 to modem 1. If the amount of data that needs to be delivered to modem 1 exceeds the capacity of CH1/T1, then CH1/T2 can also be assigned to modem 1. If modem 2 can also successfully operate on CH1, then the scheduler can assign CH1/T3 to modem 2. If modem 3 cannot operate on CH1 or CH2, but can operate on CH3, then the scheduler can assign CH3/T1 to modem 3. If modem N can successfully operate on CH1, but the scheduler has already assigned all capacity on CH1 (i.e., T1-T8), then the scheduler can drop down to the next highest channel in the spectrum and assign CH2/T1 to modem N. Thus, at least some of the blank spaces in the table of FIG. 8 are populated with assigned modems using logic such as was just illustrated, and there can also be unused timeslot/channel combinations.

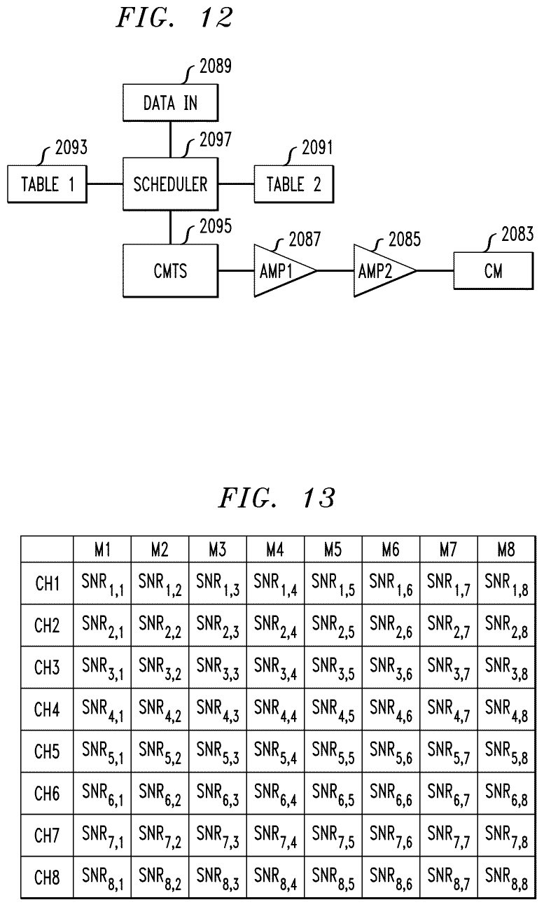

As will be discussed further below with respect to FIG. 12, one or more embodiments make use of a first table 2093 (such as is depicted in FIG. 8, mapping a modem to each time, channel combination) and a second table 2091 which includes, for example, the table generated in FIG. 10 with the capabilities of each modem. As will be discussed further below with respect to FIG. 13, the second table can include, for each modem, the operable SNR for each channel. The table can present cable 1, cable 2, . . . , cable N versus channel 1, channel 2, . . . , channel M, and the cells of the table will list the available SNR. That is to say, a particular CMTS will know, for each of the modems which it terminates, what the SNR is for each modem and channel. Meanwhile, the table 2093 such as is shown in FIG. 8 includes timeslot versus channel and the cells of the table include the modem that each timeslot and channel is assigned to. Empty or blank cells in the table mean that a particular resource was not assigned to any modem. A lightly loaded system will typically have more empty/blank cells as compared to a congested system.

In one or more instances, each channel is modulated to the maximum modulation that can be supported based on the SNR. The capacity of the system can be represented in terms of a bar graph of channel, time, and modulation, as shown in FIG. 9, where the height of each bar represents the QAM modulation level (e.g., 512, 1024, 2048, 4096, etc.). The scheduler can then assign bandwidth as appropriate to take advantage of the portions of the network that can perform at higher modulations.

Currently, DOCSIS includes a scheduler component that is used to allocate bandwidth to the cable modems on the network. As data comes in to the scheduler, the scheduler examines the data and determines where the data needs to go; then, the scheduler broadcasts the data out over the cable, allocating the data in terms of frequency (channel) and time. Furthermore in this regard, DOCSIS has a number of channels; the scheduler picks the channel it wants to use and then it identifies a particular time for the data to be transmitted. Then, the cable modem is told what part of the spectrum (frequency) to use, and what time to look at that portion of the spectrum to retrieve the data. A similar sort of thing happens in the opposite (upstream) direction, except that in the upstream direction, the modem first has to contend, and then ask for a time slot to be granted (in one or more embodiments, the modem requests bandwidth using a contention mechanism-the scheduler then informs the successful modem what channel and timeslot it can use to transmit its data in the upstream direction). Then, the system tells the modem what channel and time slot to use. Thus, in the upstream direction, there is an additional contention grant mechanism.

In the downstream direction, resources are allocated based on channel and on time. The current DOCSIS network has amplifiers and passives that were designed to operate in a certain frequency spectrum. Some current HFC plants have been updated to operate at 1 GHz. In some instances, the envelope can be further pushed to operate at 1.2 GHz, with the understanding that the higher frequencies will be subject to roll off, and thus, there will be loss of performance at the top end.

It is desirable to further upgrade existing HFC plants to 1.8 GHz amplifiers. However, carrying out such an upgrade with current techniques requires replacing all of the amplifiers in the network, which is expensive and inconvenient.

Advantageously, one or more embodiments provide techniques to determine where the cable modem is located. If the cable modem is close enough to the CMTS/RPD, and there are, say, zero or one amplifiers between the CMTS/RPD and the cable modem, then, for example, it is possible to transmit to that cable modem at the higher frequencies, and that cable modem will be able to hear the transmission and respond to it (assuming that the passives are also able to pass the higher frequencies of interest—in other words, when an amplifier is replaced/upgraded to function at higher frequencies, the corresponding taps served by that amplifier typically also need to be replaced/upgraded to pass the corresponding frequencies). Anything in the network beyond that upgraded amplifier will typically not have the required frequency response, and so, the other cable modems on the network will not see that information. For example, in FIG. 12, which is discussed in greater detail below, a cable modem located between the CMTS 2095 and AMP1 2087, and possibly a cable modem located between AMP1 2087 and AMP2 2085, might have the necessary frequency response, while the depicted cable modem 2083 downstream of AMP2 2085 might not have the necessary frequency response. In the case of zero or one amplifiers, it (AMP1) typically has to be one of the upgraded amplifiers—if the modem between AMP1 and AMP2 is to receive the SNR to support the larger QAM constellation for greater throughput.

This type of information, regarding the performance capabilities of each cable modem based on its location, can be populated into the scheduler by carrying out measurements. For example, send out high frequency signals and determine what modems are able to respond to them. Then, use that information to populate a table or database. The table or database is made available to the scheduler. Alternatively, the information can be obtained manually: for example, determine which branches are being fed by the first amplifier—the modems on those branches will be determined to be capable of operating at the higher frequency, assuming that those modems are intrinsically capable of such operation. Furthermore in this regard, in one or more embodiments, there are two factors considered in the determination of modem capability, namely, location within the network (in an SNR sense) and the innate capabilities of the modem itself. In one or more embodiments, information regarding these factors is obtained as part of a two-part process: (i) during training-up, the modem advises the CMTS what its capabilities are; and (ii) an automated signal quality query message process or manual determination process (e.g., by looking at network blueprints) to determine the network capability between the CMTS and modem. The location within the network aspect comes into play in part (ii). “Location within the network” does not necessarily mean (latitude, longitude)/ geospatial coordinates but rather how far the modem is from the CMTS in a signal/SNR perspective. The larger the SNR, the more complex modulation that can be used and thus higher bits/s/Hz. As will be appreciated by the skilled artisan, given the teachings herein, this depends on a variety of factors such as the insertion loss of the cable, length of the cable, the dimensions of the cable, and the like.

In this regard, in one or more embodiments, when the modem trains up, it is able to inform the CMTS of its capabilities. In one or more embodiments, the capabilities of the modem should also be tracked. The CMTS can maintain knowledge of modem capabilities, and that information can be stored in the network with the SNR associated with the modem for each channel. For example, if the modem does not support the higher spectrum channels, it will not be able to report an acceptable SNR for that channel. So the latter aspect can be derived in some instances. That is to say, the cable modem can respond to a signal quality query message by reporting its SNR. If a signal quality query message is sent out to the modem, asking the modem to respond with the SNR of the signal, and if the SNR is so poor that the cable modem cannot understand the message, the cable modem will be unable to respond to the message. The lack of response is, in itself, an indication that the SNR is below an acceptable level for operation when using the modulation scheme that was employed in sending the message. In the manual case, the person creating the table would find out what the modem's capabilities are from the CMTS or other records.

Once the table or database is populated, and data comes in to the scheduler, in one or more embodiments, there is an extra level of processing to determine that data is going to a particular modem (e.g., using the destination address of the data packet), and whether that modem is in reach of the high frequency portion of the network, in which case, the upper spectrum can be allocated to that cable modem, and the data can be transferred using the upper spectrum. That is to say, once the populated table or database is available, the scheduler can be rewritten in accordance with aspects of the invention to perform the appropriate calculations to take into consideration the location of the cable modem (i.e., location in the network, analogous to the attainable SNR). As noted, the “location” determination can be manual (such as based on the network drawings), or can be based on the signal response to test probes, within the reach of the upgraded amplifiers.

As used herein, including the claims, a cable modem termination system/CMTS should be understood to cover a legacy cable modem termination system, a virtualized cable modem termination system (vCMTS) as used in the DOCSIS DAA (Distributed Access Architecture) system, an RPD/vCore implementation, and the like.

Further regarding training up the modems, when the modem connects up to the network, it goes through a training sequence per step 2001 in order for it to communicate with the CMTS or vCMTS (in this regard, the “brains” are the CMTS or vCMTS, while the RPD converts the data to/from RF to transmit over the coaxial plant). Once the modem comes online, as per step 2003, there is appropriate communication regarding how many channels the modem can bond to, and what channels the modem can use. In general, with DOCSIS 3.1, most modems have a set number of channels that can be used (note that depending on the service, in some cases, only one channel may be used (for example)-the number of channels that the modem may be provisioned to use may or may not cover all the available spectrum-for example, the modem can be provisioned to use a single 192 MHz OFDM channel, but much more spectrum may be available). In some cases, a DOCSIS 4.0 has the same number of channels, but because there is more spectrum available, the system might skip some channels.

Consider now a hypothetical, non-limiting illustrative example. A DOCSIS 4.0 modem may or may not have more channels that can be provisioned than a DOCSIS 3.1 modem. However, a DOCSIS 4.0 modem is able to operate up to 1.8 GHz, whereas a DOCSIS 3.1 modem may only be able to operate up to 1.0 or 1.2 GHz. Thus, the system might skip some channels. For example, suppose there are 32 channels that the modem is capable of receiving. In DOCSIS 4.0, there may be space in the spectrum for more than 32 channels. So, instead of having all those 32 active channels adjacent to each other, they may be spread across the available spectrum. Furthermore in this regard, the “32” value may normally be associated with SC-QAM channels. Both DOCSIS 3.1 and DOCSIS 4.0 have 32 SC-QAM channels. However, they also have OFDM channels that are larger than SC-QAM channels (up to 192 MHz wide). Some DOCSIS 3.1 modems may support 2 to 4 OFDM channels. A DOCSIS 4.0 modem may support 8 OFDM channels.

In one or more embodiments, the CMTS can learn how many channels the cable modem is capable of, and what spectrum the cable modem can operate over, during the two-part process discussed elsewhere herein. There can be different types of channels in DOCSIS; for example, SC-QAM channels which are 6 MHz wide. Both DOCSIS 3.1 and DOCSIS 4.0 allow deploying 32 channels, each 6 MHz wide. A difference between DOCSIS 3.0 and DOCSIS 3.1 is the introduction of Orthogonal frequency-division multiplexing (OFDM) and Orthogonal Frequency-Division Multiple Access (OFDMA), which are much wider. OFDM channels are typically used in the downstream direction and they are 192 MHz wide (a half channel, which is 96 MHz wide, can also be employed in some instances). Thus, generally, there are different kinds of channels with different spectral widths. In one or more embodiments, when the modem is training up, it is able to communicate to the CMTS, and it reports to the CMTS what its capabilities are, including the number of channels it can support. This allows mixing between DOCSIS 3.1 modems and DOCSIS 4.0 modems. If, during the capability negotiation period, it is determined that the modem is capable of utilizing the upper spectrum, and is within reach of the high-spectrum portion of the plant, then, resources can be assigned to it.

As discussed, to determine that a particular active is able to handle communications at a higher frequency, an empirical approach sends out signals at a higher frequency, and determines whether there is a response (alternatively, a manual approach can be deployed).

As would be appreciated by the skilled artisan, the scheduler is a component within the DOCSIS specification, and in general, it can be implemented in hardware or software. Older scheduler implementations have typically been done in hardware. Given the teachings herein, aspects of the invention can be readily implemented by adapting an existing scheduler, developing a new scheduler, or a combination of both. One or more embodiments can advantageously be implemented using a software-implemented scheduler. The vCMTS scheduler is software-based. Typically, the vCMTS has a scheduler function built into it. In other words, the vCMTS also has other management and configuration capabilities in addition to the scheduler. For the avoidance of doubt, the current state-of-the-art vCMTS scheduler is software-based, and, given the teachings herein, one or more embodiments of the invention can advantageously be implemented in software by the skilled artisan, by adapting a known scheduler to implement aspects of the invention.

In a non-limiting example, the table of FIG. 8 can be implemented as a data structure within, or accessible to, the scheduler. The bar chart of FIG. 9 is a non-limiting example of the capacity that might be available on the different channels at different times. The tallest bars 2099 in the back of FIG. 9 correspond to high frequency channels (e.g., QAM 4096) that can carry more data. In the non-limiting example of FIG. 9, the QAM modulation level C1 is 4096; C2 and C3 are 2048; C4-C7 are 1024; and C8 is 512. Note that DOCSIS also has other modulation levels including 8K QAM and 16K QAM, and that FIG. 9 is illustrative and non-limiting.

The three initialization steps in FIG. 10 can be done prior to the scheduler, as part of the set-up process. In one or more embodiments, the train up process, discussed above, involves both the CMTS and modem(s). During the performance determination step, the CMTS or vCMTS learns the capability of the modems (For example, the modem informs the CMTS of its capabilities, while through the (signal quality query message) process of transmitting a high frequency communication 1, and the modem responding with the SNR (or lack of a response because the SNR is too low), and then a second highest frequence communication 2, etc., the CMTS can learn what SNR levels are achievable to that particular modem and store that information in the network). The CMTS can be in communication with/controlled by scheduler for this step, for example. Signals are sent out, in manual or automated fashion, from the CMTS. In the last step in FIG. 10, the information is stored in the data structure (for example, the CMTS manages where the data structure is located in the network, and populates it based on the results of the process discussed above) so that the scheduler will know the capabilities of each cable modem, based on cable modem characteristics and location in the network, as discussed/defined elsewhere herein. In one or more embodiments, the data structure is in, or accessible to, the scheduler.

In one or more embodiments, during training, the modem informs the CMTS of its device capabilities. Then, another process is conducted, involving testing for the SNR of each channel, which is used to determine what modulations can be supported by the channels the modem can use. Determining the SNR can occur immediately after training, and then later it can be periodically executed to update the table if there have been any changes to the network that have affected the SNR.

In one or more embodiments, the logic of the flow chart of FIG. 11 is performed within the scheduler; most readily in a software-based scheduler (however, in another non-limiting example, a hybrid scheduler, part hardware and part software, could be used). In the latter case, the software part would have sufficient intelligence to manage all the resources based on high-frequency capability versus channel versus time.

Refer now to the exemplary system block diagram of FIG. 12. Note the scheduler 2097 implementing aspects of the invention, such as at least a portion of the logic depicted in the flow charts. Data 2089 to be sent downstream comes in to the scheduler 2097. Scheduler 2097 has access to data structures or the like including Table 1 2093 and Table 2 2091. Table 1 2093 can include, for example, a table such as is depicted in FIG. 8, mapping a modem to each time, channel combination (or leaving a cell blank when a given time, channel combination is not to be used). Table 2 2091 can include, for example, the table generated in FIG. 10 with the capabilities of each modem (FIG. 13, discussed just below, provides an example). The data structures of Table 1 and/or Table 2 can be remote/in the cloud, or collocated with the scheduler 2097, for example. Generally, they can be stored in a non-volatile memory on or accessible to server or the like, and can be accessed by READ statements, database queries, etc. In one or more embodiments, the scheduler 2097 is implemented in software on a server and optionally collocated with the CMTS 2095 or vCMTS. In a non-limiting example of a collocated scheduler and CMTS, the scheduler could be located on a server in the same premises as the CMTS and could be cabled to the CMTS instead of being coupled by a WAN. In another aspect, the scheduler can also be integrated into the CMTS—in this aspect, a processor on the CMTS implements the scheduler. First and second amplifiers AMP1 2087 and AMP2 2085, respectively, are downstream from CMTS 2095 and upstream from the cable modem CM 2083. CMTS 2095 can be similar, for example, to CMTS 156 described above. It should be noted that the exemplary architecture in FIG. 3 shows a traditional location for the CMTS 156 in a head end. As will be appreciated by the skilled artisan, CMTS functionality can be moved down closer to the customers or up to a national or regional data center or can be dispersed into one or more locations. Cable modem CM 2083 can be part of an integrated unit such as CPE 106 of FIG. 6, can be stand-alone, can be paired with a router, or the like. CMTS 2095 is connected to CM 2083 over HFC network 101, for example. Scheduler 2097 can be collocated with CMTS 2095, connected by a WAN, integrated together, etc. Scheduler 2097 can host the tables locally or access them over a network, for example. In one or more embodiments, the amplifiers 2087, 2089 are RF amps in the cable part of the HFC network downstream from the fiber node 178. Note that while FIG. 4 depicts a “classic” HFC network, in another aspect, in FIG. 4, element 182 could be equivalent to the RPD. In this aspect, elements to the left of element 182 could be fiber and elements to the right could be coaxial cable. In FIG. 12, regarding the DATA IN block 2089, in one or more embodiments the data comes from the Internet 1002 through the NDC 1098, router 1008, DWDM 1046 and into the head end 150 (or to wherever else in the network the scheduler is located).

FIG. 13 is an exemplary table of achievable SNR per channel for each modem of a plurality of modems connected to a CMTS, in accordance with an aspect of the invention. In the example, a particular cable modem has 8 available channels and is connected to 8 cable modems, but the number of available channels and the number of connected modems can, in general, be the same or different. Each cell in the table include the achievable SNR for a given channel, modem combination, where the first subscript is the channel number and the second is the modem number.

As noted elsewhere, as used herein, including the claims, a cable modem termination system should be broadly understood to include both legacy iCMTS architectures and DAA (Distributed Access Architecture) systems. In DAA, the combination of a vCMTS and RPD or the combination of a MAC Manager and Remote MACPHY Device (RMD) has the equivalent function of a CMTS. Refer also to the discussion of the vCore/RPD alternative just below, since the vCMTS is a component of the vCore. In the case of the MAC Manager/ RMD, the overall system functionality is equivalent, but the location of the MAC function is moved to the RMD. element 2095 should be broadly understood as representative of both legacy and virtual implementations.

RPD/vCore alternative: Another non-limiting exemplary aspect will now be discussed (note that the vCMTS is a component of the vCore). In this regard, MAC and PHY layers are concepts familiar to the ordinary skilled worker; generally, the MAC layer controls the timing of signals to be sent from or received by equipment, while the PHY layer generates or receives the actual signals on the physical connection. The skilled artisan will also be familiar with the Converged Cable Access Platform (CCAP), the concept of a remote physical device (RPD), and with the existing “Remote-Phy” standards, including Data-Over-Cable Service Interface Specifications DCA-MHAv2, Modular Headend Architecture v2 Technical Report, CM-TR-MHAv2-V01-150615, Cable Television Laboratories, Inc. 2014-2015, Jun. 15, 2015, and Data-Over-Cable Service Interface Specifications DCA, Distributed CCAP Architectures Overview Technical Report, CM-TR-DCA-V01-150908, Cable Television Laboratories, Inc. 2015, Sep. 8, 2015, both of which are hereby expressly incorporated herein by reference in their entireties for all purposes. The Remote PHY technology allows for an integrated CCAP to be separated into two components: the CCAP Core and the Remote PHY Device (RPD). One of the common locations for an RPD is the optical node device that is located at the junction of the fiber and coax plants, while the CCAP Core stays at the headend. A CCAP core can control and setup data paths with multiple RPDs situated in multiple fiber nodes. The Remote PHY technology uses pseudowires between a CCAP Core and a set of RPDs. The CCAP Core contains both a CMTS Core for supporting DOCSIS data transport and an Edge QAM Core for supporting video transport. The CMTS Core contains the DOCSIS MAC (signaling functions, downstream and upstream bandwidth scheduling, and DOCSIS framing) and the upper layer protocols. Remote PHY supports both DOCSIS 3.0, 3.1 & 4.0 Specifications. The EQAM Core contains known video processing functions. The skilled artisan will also be familiar with the virtual core (vCore) concept. As will be appreciated by the skilled artisan given the teachings herein, embodiments of the invention can utilize RPD/vCore functionality.

It is worth noting that the skilled artisan will be familiar with DOCSIS management messaging for a CMTS and/or scheduler to retrieve information from a modem.

Given the discussion thus far, it will be appreciated that, in general terms, an exemplary method, according to an aspect of the invention, includes the step 2007 of, at a scheduler component 2097 of a cable network 101, obtaining first data designated for a first downstream component 2083 (e.g., based on IP address) of the cable network. As used herein, a “cable network” includes both a “pure” cable network and an HFC network, as distinguished from a wireless network, for example. A further step 2009 includes, at the scheduler component, determining whether the first downstream component is capable of receiving the first data via a first channel of at least first and second available channels for the first downstream component, where the first channel for the first downstream component has a modulation scheme capable of higher spectral efficiency than that for the second channel for the first downstream component.

It is worth noting that the channels can, but need not be, QAM channels. Any modulation that generates a certain level of spectral efficiency can be employed; by way of example and not limitation, QAM, BPSK, PSK, QPSK, and the like. Each modulation has a different level of complexity. QPSK has a constellation of four points; in QAM, there are schemes such as 16 QAM, 64 QAM, 4K QAM, 8K QAM, and so on. In the case of QAM modulations, the more points in the constellation, the more bits/s/Hz that can be realized. One or more embodiments assess which modulation(s) can be supported and then it is known how many bits/s/Hz that each modulation can provide—one or more embodiments seek to maximize the number of bits/s/Hz that can be achieved by creating the SNR table with the modulations of interest. Different modulations are capable of providing different levels of bits/s/Hz capacity—typically, more complex modulations result in a greater bits/s/Hz value/higher spectral efficiency. Different modulations also require different levels of SNR.

Now continuing, still a further step (responsive to the YES evaluation of decision block 2009) includes, at the scheduler component, responsive to determining that the first downstream component is capable of receiving the first data via the first channel for the first downstream component, populating a first table 2093 to assign the first channel for the first downstream component to the first downstream component at a first specified time, as per step 2015.

Still a further step includes operating the cable network in accordance with the populated first table. In one or more embodiments, the first table can be populated a priori. As cable modems (CMs) come on line, the best SNR at the CM receiver and at the RPD receiver from the CM can be determined for each of the different spectrum channels of interest. It can also be done manually by calculating the losses from the geometries of the deployment and the information stored. The manual method may, in at least some instances, be more prone to errors, and more challenging to update if there are changes in the network. In one or more embodiments, the information is stored in the network (cloud, vCMTS, or any other suitable location, as long as the scheduler can reach the information). Then, in one or more embodiments, the SNR can be periodically checked to see if it has changed. Along with the SNR (or similar (e.g., CNR)) information, a mapping of what SNR corresponds to what constellation size can be implemented. In this manner, when the scheduler looks up the CM, it can retrieve the constellation size that will work without errors for that particular CM for a given spectrum channel. The scheduler can run an algorithm to maximize the overall throughput of the system by assigning modems with high SNR on high spectrum channels to modems that are capable. Now that the table is populated and accessible, when data appears at the scheduler, the scheduler determines which modem is to receive the data, looks up the SNR information, and uses that information to select which spectrum channel to use that will result in optimum performance.

Note that, as used herein, a “high” QAM channel means a large constellation QAM channel; in other words, a channel with sufficient SNR to support a large QAM constellation (e.g., 4K QAM, 16K QAM, etc.).

Note also that the skilled artisan will be familiar with Shannon's Theorem and the Shannon-Hartley Theorem. The Shannon-Hartley theorem shows that the greater the SNR, the greater the capacity of the channel. Larger QAM constellations require a greater SNR because the points in the constellation are closer together in larger constellations. Factors that impact the SNR include distance. The greater the distance, the more the signal is attenuated while the noise floor stays the same, resulting in a lower SNR.

One or more embodiments further include (repeated step 2007), at the scheduler component of the cable network, obtaining second data designated for a second downstream component of the cable network. Steill a further step includes (repeated step 2009), at the scheduler component, determining whether the second downstream component is capable of receiving the second data via a first channel of at least first and second available channels for the second downstream component, wherein the first channel for the second downstream component has a modulation scheme capable of higher spectral efficiency than that for the second channel for the second downstream component.

An even further step 2011 includes, at the scheduler component, responsive to determining that the second downstream component is not capable of receiving the second data via the first channel for the second downstream component (repeated step 2009—NO branch), further populating the first table to assign the second channel for the second downstream component to the second downstream component at a second specified time. Note that the second downstream component might not be capable of receiving the second data via the first channel for the second downstream component due, for example, to being downstream of a non-upgraded amplifier.

In this aspect of repeating the various steps, the operating of the cable network in accordance with the first table includes operating the cable network in accordance with the further populated first table.

In one or more embodiments, the steps of determining whether the first downstream component is capable of receiving the first data via the first channel for the first downstream component and determining whether the second downstream component is capable of receiving the second data via the first channel for the second downstream component are based on a second table 2091 including channel/modulation information for the first and second downstream components.

In one or more embodiments, the first and second downstream components include cable modems 2083, and further steps (see 2001, 2003) include determining optimal channel/modulations for each of the modems based on a training process for each of the modems and a location of each of the modems within the network (as discussed elsewhere, location in an SNT sense); and, as per 2005, storing the optimal channel/modulations for each of the modems in the second table. For example, the scheduler 2097 can control the CMTS 2095 for this aspect.

As discussed elsewhere herein, the location of each of the modems within the network can be at least partially determined manually; on the other hand, the location of each of the modems within the network can be at least partially determined by a response or lack of response of each of the modems to a message from a cable modem termination system of the network, requesting a signal quality parameter (e.g., SNR, CNR) per channel.

It is worth noting that one or more embodiments can utilize a table, such as in FIG. 13, to maximize/optimize capacity of the cable network. A non-limiting, exemplary algorithm starts with the highest spectrum first. Identify the modem that has the best SNR, configure the system to modulate the data at the largest constellation that can be supported with the observed SNR, and assign as much data as can be supported to be delivered to that modem based on the spectrum/constellation determined. Then go to the next highest spectrum and repeat, and so on. Thus, in one or more embodiments, the steps of populating the first table and further populating the first table are carried out to maximize capacity of the cable network.

One or more embodiments further include, at the scheduler component of the cable network, obtaining third data designated for a third downstream component of the cable network; and, at the scheduler component, determining whether the third downstream component is capable of receiving the third data via a first channel of at least first, second, and third available channels for the third downstream component. The first channel for the third downstream component has a modulation scheme capable of higher spectral efficiency than that of the second channel for the third downstream component and the second channel for the third downstream component has a modulation scheme capable of higher spectral efficiency than that of the third channel for the third downstream component. A further step (e.g., 2013) include, at the scheduler component, responsive to determining that the third downstream component is capable of receiving the third data via the first channel for the third downstream component, checking whether the first channel for the third downstream component is available. Still a further step (responsive to 2013 NO) includes, at the scheduler component, responsive to the checking reveling that the first channel for the third downstream component is not available, still further populating the first table to assign the second channel for the third downstream component to the third downstream component at a third specified time, as per step 2019. In this aspect, the operating of the cable network in accordance with the first table includes operating the cable network in accordance with the still further populated first table.

One or more embodiments further include progressively replacing amplifiers of the cable network starting from a most upstream amplifier 2087 and working downstream to a most downstream amplifier 2085 towards a most downstream of the first and second downstream components. Additionally, in one or more embodiments, it can be appropriate to place an intermediate amplifier between the upgraded amplifier and the next amplifier that has not yet been upgraded/replaced, depending on the link budget at the high end of the spectrum and the current amplifier spacing.

The first and second downstream components can include, for example, at least one of actives and passives. In this aspect, when an amplifier is upgraded/ replaced, all passives directly served by that amplifier should typically also be upgraded/replaced to match or exceed the performance of the high-end side of the support spectrum in order to maximize the benefit of the replacement/upgrade. In this aspect, tables for the passive component are not necessarily needed. Note that an amplifier is an example of an active component while a tap is an example of a passive modem that is subtended to the tap. If a tap is only designed for 1 GHz instead of 1.8 GHz, there will typically be additional attenuation which will impact the SNR.

In another aspect, an exemplary system includes electronic circuitry configured to implement a scheduler component of a cable network. The electronic circuitry is configured to carry out or otherwise facilitate any one, some, or all of the above-discussed method steps.

In one or more embodiments, the system further includes the cable network; the cable network is coupled to the electronic circuitry, and the cable network is configured to operate in accordance with the populated first table.

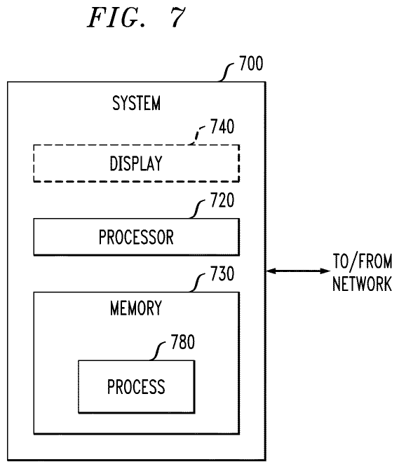

Referring, for example, to FIG. 7, in some instances, the electronic circuitry includes a memory, and at least one processor, coupled to the memory, and operative to carry out the obtaining, determining, and populating.

The system can include any one, some, or all of the components shown in FIG. 12 and the other figures.

In one or more embodiments, the scheduler has a processor, Table 1 and Table 2 are in memory, and the scheduler at least has registers that the data “drops into” before it is transmitted on. In some instances, the scheduler is implemented software; however, full or partial hardware implementations are also possible in some instances. Some embodiments can have a hardware scheduler with external processing that handles Tables 1 and 2. As would be appreciated by the skilled artisan, the scheduler could be implemented by synthesizing custom circuitry using known computer-aided design and computer-aided fabrication techniques including hardware description language or the like, can be implemented using an ASIC and/or an FPGA, and any combination thereof.

### System and Article of Manufacture Details

Different aspects of the invention can employ hardware aspects, software aspects, or a combination of hardware and software aspects. Software includes but is not limited to firmware, resident software, microcode, etc. One or more embodiments of the invention or elements thereof can be implemented in the form of an article of manufacture including a machine-readable medium that contains one or more programs which when executed implement such step(s); that is to say, a computer program product including a tangible computer readable recordable storage medium (or multiple such media) with computer usable program code configured to implement the method steps indicated, when run on one or more processors. Furthermore, one or more embodiments of the invention or elements thereof can be implemented in the form of an apparatus including a memory and at least one processor that is coupled to the memory and operative to perform, or facilitate performance of, exemplary method steps.

Yet further, in another aspect, one or more embodiments of the invention or elements thereof can be implemented in the form of means for carrying out one or more of the method steps described herein; the means can include (i) specialized hardware module(s), (ii) software module(s) executing on one or more general purpose or specialized hardware processors, or (iii) a combination of (i) and (ii); any of (i)-(iii) implement the specific techniques set forth herein, and the software modules are stored in a tangible computer-readable recordable storage medium (or multiple such media). Appropriate interconnections via bus, network, and the like can also be included.

As is known in the art, part or all of one or more aspects of the methods and apparatus discussed herein may be distributed as an article of manufacture that itself includes a tangible computer readable recordable storage medium having computer readable code means embodied thereon. The computer readable program code means is operable, in conjunction with a computer system, to carry out all or some of the steps to perform the methods or create the apparatuses discussed herein. A computer readable medium may, in general, be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). As used herein, a tangible computer-readable recordable storage medium is defined to encompass a recordable medium, examples of which are set forth above, but is defined not to encompass transmission media per se or disembodied signals per se. Appropriate interconnections via bus, network, and the like can also be included.

FIG. 7 is a block diagram of at least a portion of an exemplary system 700 that can be configured to implement at least some aspects of the invention, and is representative, for example, of one or more of the apparatuses, servers, or modules shown in the figures. As shown in FIG. 7, memory 730 configures the processor 720 to implement one or more methods, steps, and functions (collectively, shown as process 780 in FIG. 7). The memory 730 could be distributed or local and the processor 720 could be distributed or singular. Different steps could be carried out by different processors, either concurrently (i.e., in parallel) or sequentially (i.e., in series).

The memory 730 could be implemented as an electrical, magnetic or optical memory, or any combination of these or other types of storage devices. It should be noted that if distributed processors are employed, each distributed processor that makes up processor 720 generally contains its own addressable memory space. It should also be noted that some or all of computer system 700 can be incorporated into an application-specific or general-use integrated circuit. For example, one or more method steps could be implemented in hardware in an application-specific integrated circuit (ASIC) or field-programmable gate array (FPGA) rather than using firmware. Display 740 is representative of a variety of possible input/output devices (e.g., keyboards, mice, and the like). Every processor may not have a display, keyboard, mouse or the like associated with it.

The computer systems and servers and other pertinent elements described herein each typically contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more embodiments of the present invention can include a computer program comprising computer program code means adapted to perform one or all of the steps of any methods or claims set forth herein when such program is run, and that such program may be embodied on a tangible computer readable recordable storage medium. As used herein, including the claims, unless it is unambiguously apparent from the context that only server software is being referred to, a “server” includes a physical data processing system running a server program. It will be understood that such a physical server may or may not include a display, keyboard, or other input/output components. Furthermore, as used herein, including the claims, a “router” includes a networking device with both software and hardware tailored to the tasks of routing and forwarding information. Note that servers and routers can be virtualized instead of being physical devices (although there is still underlying hardware in the case of virtualization).

Furthermore, it should be noted that any of the methods described herein can include an additional step of providing a system comprising distinct software modules or components embodied on one or more tangible computer readable storage media. All the modules (or any subset thereof) can be on the same medium, or each can be on a different medium, for example. The modules can include any or all of the components shown in the figures. The method steps can then be carried out using the distinct software modules of the system, as described above, executing on one or more hardware processors. Further, a computer program product can include a tangible computer-readable recordable storage medium with code adapted to be executed to carry out one or more method steps described herein, including the provision of the system with the distinct software modules.

Accordingly, it will be appreciated that one or more embodiments of the invention can include a computer program including computer program code means adapted to perform one or all of the steps of any methods or claims set forth herein when such program is implemented on a processor, and that such program may be embodied on a tangible computer readable recordable storage medium. Further, one or more embodiments of the present invention can include a processor including code adapted to cause the processor to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising:
at a scheduler component of a cable network, obtaining first data designated for a first downstream component of the cable network;
at the scheduler component, determining whether the first downstream component is capable of receiving the first data via a first channel of at least first and second available channels for the first downstream component, wherein the first channel for the first downstream component has a modulation scheme capable of higher spectral efficiency than that for the second channel for the first downstream component;
at the scheduler component, responsive to determining that the first downstream component is capable of receiving the first data via the first channel for the first downstream component, populating a first table to assign the first channel for the first downstream component to the first downstream component at a first specified time; and
operating the cable network in accordance with the populated first table.

2. The method of claim 1, further comprising:
at the scheduler component of the cable network, obtaining second data designated for a second downstream component of the cable network;
at the scheduler component, determining whether the second downstream component is capable of receiving the second data via a first channel of at least first and second available channels for the second downstream component, wherein the first channel for the second downstream component has a modulation scheme capable of higher spectral efficiency than that for the second channel for the second downstream component; and
at the scheduler component, responsive to determining that the second downstream component is not capable of receiving the second data via the first channel for the second downstream component, further populating the first table to assign the second channel for the second downstream component to the second downstream component at a second specified time; and
wherein the operating of the cable network in accordance with the first table comprises operating the cable network in accordance with the further populated first table.

3. The method of claim 2, wherein the steps of determining whether the first downstream component is capable of receiving the first data via the first channel for the first downstream component and determining whether the second downstream component is capable of receiving the second data via the first channel for the second downstream component are based on a second table including channel/modulation information for the first and second downstream components.

4. The method of claim 3, wherein the first and second downstream components comprise cable modems, further comprising:
determining optimal channel/modulations for each of the modems based on a training process for each of the modems and a location of each of the modems within the network; and
storing the optimal channel/modulations for each of the modems in the second table.

5. The method of claim 4, wherein the location of each of the modems within the network is at least partially determined manually.

6. The method of claim 4, wherein the location of each of the modems within the network is at least partially determined by a response or lack of response of each of the modems to a message from a cable modem termination system of the network, requesting a signal quality parameter per channel.

7. The method of claim 3, wherein the steps of populating the first table and further populating the first table are carried out to maximize capacity of the cable network.

8. The method of claim 7, further comprising:
at the scheduler component of the cable network, obtaining third data designated for a third downstream component of the cable network;
at the scheduler component, determining whether the third downstream component is capable of receiving the third data via a first channel of at least first, second, and third available channels for the third downstream component, wherein the first channel for the third downstream component has a modulation scheme capable of higher spectral efficiency than that of the second channel for the third downstream component and the second channel for the third downstream component has a modulation scheme capable of higher spectral efficiency than that of the third channel for the third downstream component;
at the scheduler component, responsive to determining that the third downstream component is capable of receiving the third data via the first channel for the third downstream component, checking whether the first channel for the third downstream component is available;
at the scheduler component, responsive to the checking reveling that the first channel for the third downstream component is not available, still further populating the first table to assign the second channel for the third downstream component to the third downstream component at a third specified time; and
wherein the operating of the cable network in accordance with the first table comprises operating the cable network in accordance with the still further populated first table.

9. The method of claim 3, further comprising progressively replacing amplifiers of the cable network starting from a most upstream amplifier and working downstream to a most downstream amplifier towards a most downstream of the first and second downstream components.

10. The method of claim 3, wherein the first and second downstream components comprise at least one of actives and passives.

11. The method of claim 1, wherein the cable network comprises a hybrid fiber-cable network.

12. The method of claim 11, wherein the hybrid fiber-cable network comprises a DOCSIS network.

13. A non-transitory computer readable medium comprising computer executable instructions which when executed by a processor cause the processor to perform a method comprising the steps of:
at a scheduler component of a cable network, obtaining first data designated for a first downstream component of the cable network;
at the scheduler component, determining whether the first downstream component is capable of receiving the first data via a first channel of at least first and second available channels for the first downstream component, wherein the first channel for the first downstream component has a modulation scheme capable of higher spectral efficiency than that for the second channel for the first downstream component;
at the scheduler component, responsive to determining that the first downstream component is capable of receiving the first data via the first channel for the first downstream component, populating a first table to assign the first channel for the first downstream component to the first downstream component at a first specified time; and
facilitating operation of the cable network in accordance with the populated first table.

14. A system comprising:
electronic circuitry configured to implement a scheduler component of a cable network, the electronic circuitry being configured to:
obtain first data designated for a first downstream component of the cable network;
determine whether the first downstream component is capable of receiving the first data via a first channel of at least first and second available channels for the first downstream component, wherein the first channel for the first downstream component has a modulation scheme capable of higher spectral efficiency than that for the second channel for the first downstream component;
responsive to determining that the first downstream component is capable of receiving the first data via the first channel for the first downstream component, populate a first table to assign the first channel for the first downstream component to the first downstream component at a first specified time; and
facilitate operating the cable network in accordance with the populated first table.

15. The system of claim 14, further comprising the cable network, the cable network being coupled to the electronic circuitry, wherein the cable network is configured to operate in accordance with the populated first table.

16. The system of claim 15, wherein the electronic circuitry includes a memory, and at least one processor, coupled to the memory, and operative to carry out the obtaining, determining, and populating.

17. The system of claim 16, wherein:
the at least one processor is further operative to:
obtain second data designated for a second downstream component of the cable network;
determine whether the second downstream component is capable of receiving the second data via a first channel of at least first and second available channels for the second downstream component, wherein the first channel for the second downstream component has a modulation scheme capable of higher spectral efficiency than that for the second channel for the second downstream component; and
responsive to determining that the second downstream component is not capable of receiving the second data via the first channel for the second downstream component, further populating the first table to assign the second channel for the second downstream component to the second downstream component at a second specified time; and
the operating of the cable network in accordance with the first table comprises operating the cable network in accordance with the further populated first table.

18. The system of claim 17, wherein the determination of whether the first downstream component is capable of receiving the first data via the first channel for the first downstream component and the determination of whether the second downstream component is capable of receiving the second data via the first channel for the second downstream component are based on a second table including channel/modulation information for the first and second downstream components, the first and second tables being stored in a data structure coupled to the at least one processor.

19. The system of claim 18, further comprising the first and second downstream components, wherein the first and second downstream components comprise cable modems, wherein the at least one processor is further operative to:
facilitate determining optimal channel/modulations for each of the modems based on a training process for each of the modems and a location of each of the modems within the network; and
store the optimal channel/modulations for each of the modems in the second table.

20. The system of claim 19, further comprising a cable modem termination system of the network, wherein the location of each of the modems within the network is at least partially determined by a response or lack of response of each of the modems to a message from the cable modem termination system of the network, requesting a signal quality parameter per channel.

21. The system of claim 18, wherein the populating of the first table and the further populating of the first table are carried out to maximize capacity of the cable network.

22. The system of claim 21, wherein:
the at least one processor is further operative to:
obtain third data designated for a third downstream component of the cable network;
determine whether the third downstream component is capable of receiving the third data via a first channel of at least first, second, and third available channels for the third downstream component, wherein the first channel for the third downstream component has a modulation scheme capable of higher spectral efficiency than that of the second channel for the third downstream component and the second channel for the third downstream component has a modulation scheme capable of higher spectral efficiency than that of the third channel for the third downstream component;
responsive to determining that the third downstream component is capable of receiving the third data via the first channel for the third downstream component, check whether the first channel for the third downstream component is available; and
responsive to the checking reveling that the first channel for the third downstream component is not available, still further populate the first table to assign the second channel for the third downstream component to the third downstream component at a third specified time; and
the operating of the cable network in accordance with the first table comprises operating the cable network in accordance with the still further populated first table.

23. The system of claim 18, wherein the first and second downstream components comprise at least one of actives and passives.

24. The system of claim 16, wherein the cable network comprises a hybrid fiber-cable network.

25. The system of claim 24, wherein the hybrid fiber-cable network comprises a DOCSIS network.
